(19) United States
(12) Patent Application Publication
(10) Pub. No.: US 2009/0202071 A1
(43) Pub. Date: Aug. 13, 2009

(54) RECORDING APPARATUS, REPRODUCING APPARATUS, AND COMPUTER PROGRAM PRODUCT FOR RECORDING AND REPRODUCING

(75) Inventor: Taku KATO, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 12/364,058

(22) Filed: Feb. 2, 2009

(30) Foreign Application Priority Data
Feb. 13, 2008 (JP) 2008-032028

(51) Int. Cl. H04N 7/167

(52) U.S. Cl. 380/201

(57) ABSTRACT

A recording apparatus stores first secret information uniquely allocated to the recording apparatus, reads media identification information for specifically identifying a recordable medium and encrypted disk key information encrypted by master key information from the recordable medium, and transmits these pieces of information to an authentication server. The recording apparatus receives an encrypted content encrypted by title key information and encrypted title key information from the authentication server. Further, the recording apparatus receives first certificate information for certifying that the authentication server permits recording of the content on the recordable medium from the authentication server, generates second certificate information by using the first certificate information and first secret information, and records the encrypted content, the encrypted title key information, and the second certificate information on the recordable medium.

### CROSS-REFERENCE TO RELATED APPLICATIONS

This application is based upon and claims the benefit of priority from the prior Japanese Patent Application No. 2008-32028, filed on Feb. 13, 2008; the entire contents of which are incorporated herein by reference.

### BACKGROUND OF THE INVENTION

1. Field of the Invention

The present invention relates to a recording apparatus for recording contents on a recording medium in such a manner that an illegal copy thereof cannot be made, a reproducing apparatus that reproduces the contents recorded on the recording medium, a computer program product for recording and reproducing.

2. Description of the Related Art

Since the launch in 1996, digital versatile disc (DVD), on which a digital content (hereinafter, simply “content”) such as a movie are recorded, has established a huge market. As one reason thereof, it can be considered that content providers can distribute and market their contents safely by encrypting the contents. In the DVD, a technique referred to as a content scramble system (CSS) is used for encrypting the content. A DVD player for reproducing the CSS encrypted DVD has a private key (master key) for decrypting the CSS encrypted DVD. The private key is not specific to each DVD player, but is specifically determined for each DVD player manufacturer. Therefore, when the private key is leaked, it is necessary to revoke all the DVD players manufactured by player manufacturers, to which the private key is allocated, so that the leaked private key cannot be used (is revoked). However, actual revocation may confuse users who use the DVD players manufactured by same manufacturer, and therefore actual revocation is almost impossible.

All the private keys allocated to the player manufacturers are also used at the time of manufacturing the DVD-Video using a read only memory (ROM) type DVD (DVD-ROM). These keys are strictly managed, and therefore it is quite difficult to illegally manufacture the CSS encrypted DVD-video. Recently, there has been considered a usage format such that the CSS encrypted content is downloaded and recorded on a recordable type DVD (recordable-DVD). In this format, as a method of recording key data required for the CSS encryption, there has been considered a method such that the key data required for the CSS encryption is recorded in advance in a read-only area (lead-in area) of a recordable-DVD at the time of manufacturing the recordable-DVD.

Further, as a method of encrypting the content and recording the content on the recordable-DVD, there is a technique referred to as content protection for recordable media (CPRM) technology licensed by 4C Entity, LLC. This technology is disclosed in, for example, CPRM specification, 4C Entity, LLC, http://www.4centity.com/technologies.html. According to this technology, to prevent that the content is copied bit-by-bit on another recordable-DVD in an encrypted state, a measure for performing encryption adjusted to the recordable-DVD as a recording target of the content by using a unique number (media identifier: media ID), which is different for each recordable-DVD, written in advance at the time of manufacturing the recordable-DVD is adopted. In CPRM-compatible equipment that can reproduce the content, a device key set specific to the equipment is held, and the CPRM encrypted content can be decrypted and reproduced by using the device key set and the media ID.

However, according to the CSS technology, it is difficult to provide a different value for each piece of recordable-DVD as the key data recorded in the read-only area, due to a problem of production cost or the like, and only limited types (variations) are prepared as a whole. Therefore, there is still a risk of illegal copy of the content. For example, if a recordable-DVD having the same key data recorded thereon as that of a record-DVD, which records the CSS encrypted and downloaded content, is searched, to copy the content bit-by-bit, an identical medium can be produced in plural. That is, in the DVD-ROM, it is quite difficult to illegally produce the DVD-video, whereas when the recordable-DVD is used, there is a concern that an illegal DVD-Video may be produced by illegally altering a generally-distributed DVD write unit (recordable DVD drive).

In the CPRM technology, the media ID is used for the encryption of content as a measure against bit-by-bit copy. However, when the device key set, which should be kept secret in the CPRM-compatible equipment held by a general user, is leaked, the content encrypted by the CPRM may be generated by using the device key set.

For example, different from the DVD recorded by a device held by the general user and managed, a DVD on which the content is recorded as package media can be originally manufactured only in a media pressing factory, as the content added with copyright information, encrypted, and broadcast. Nevertheless, when the content is downloaded on the recordable-DVD, even an ordinary user can make an illegal copy, which leads to a major problem. Therefore, it has been desired to suppress illegal copying of the content at the time of recording the content on the recordable-DVD.

### SUMMARY OF THE INVENTION

According to one aspect of the present invention, a recording apparatus connected to an authentication server that permits recording of a content via a network, to record an encrypted content on a recordable medium, the apparatus includes a storage unit that stores first secret information uniquely allocated to the recording apparatus; a read unit that reads media identification information for specifically identifying the recordable medium, and encrypted disk key information which is disk key information encrypted by master key information, from the recording medium; a transmitting unit that transmits the media identification information and the encrypted disk key information to the authentication server; a first receiving unit that receives the encrypted content which is a content encrypted by title key information uniquely allocated to each content, and encrypted title key information which is the title key information encrypted by the disk key information, from the authentication server; a second receiving unit that receives first certificate information for certifying that the authentication server permits recording of the content on the recordable medium, which is generated by using at least the media identification information, from the authentication server; a generating unit that generates second certificate information by using the first certificate information and the first secret information; and a recording unit that records the encrypted content, the encrypted title key information, and the second certificate information on the recordable medium.

According to another aspect of the present invention, a reproducing apparatus that reproduces a content encrypted and recorded on a recordable medium, the apparatus includes a storage unit that stores master key information; a read unit that reads encrypted disk key information which is disk key information encrypted by the master key information, an encrypted content which is a content encrypted by title key information uniquely allocated to each content, and encrypted title key information which is the title key information encrypted by the disk key information, from the recordable medium; a decrypting unit that decrypts the encrypted disk key information by using the master key information, and decrypts the encrypted title key information by using the decrypted disk key information, thereby obtaining the title key information; a verifying unit that verifies whether recording of the encrypted content on the recordable medium is permitted by an authentication server, by using at least media identification information capable of specifically identifying the recordable medium, and second certificate information generated by a recording apparatus by using first certificate information, which is generated by using at least the media identification information, for certifying that the authentication server permits recording of the content on the recordable medium, and first secret information uniquely allocated to the recording apparatus, when the media identification information and the second certificate information are recorded on the recordable medium; and a reproducing unit that decrypts the encrypted content by using the title key information to reproduce the content, when it is verified that recording of the encrypted content on the recordable medium is permitted by the authentication server.

According to still another aspect of the present invention, a reproducing apparatus that reproduces a content encrypted and recorded on a recordable medium, the apparatus includes a storage unit that stores master key information; a read unit that reads encrypted disk key information, which is disk key information encrypted by the master key information, an encrypted content, which is a content having a digital watermark embedded therein for indicating that an authentication server that permits recording of contents permits recording of the content on the recordable medium and encrypted by title key information uniquely allocated to each content, and encrypted title key information, which is the title key information encrypted by the disk key information, from the recordable medium; a decrypting unit that decrypts the encrypted disk key information by using the master key information, and decrypts the encrypted title key information by using the decrypted disk key information, to thereby obtain the title key information; a reproducing unit that decrypts the encrypted content by using the title key information, to reproduce the content; a detecting unit that detects the digital watermark from the content to be reproduced; and a verifying unit that verifies whether recording of the encrypted content on the recordable medium is permitted by the authentication server, by using at least media identification information capable of specifically identifying the recordable medium, and second certificate information generated by a recording apparatus by using first certificate information, which is generated by using at least the media identification information, for certifying that the authentication server permits recording of the content on the recordable medium, and first secret information uniquely allocated to the recording apparatus, when the appropriate digital watermark is detected and the media identification information and the second certificate information are recorded on the recordable medium, wherein when the appropriate digital watermark is detected and the media identification information and the second certificate information are not recorded on the recording medium, or when it is verified that recording of the encrypted content is not permitted by the authentication server, the reproducing unit aborts reproduction of the content.

According to still another aspect of the present invention, a computer program product having a computer readable medium including programmed instructions, when executed by a computer provided in a recording apparatus connected to an authentication server that permits recording of a content via a network, to record an encrypted content on a recordable medium, and includes a storage unit that stores first secret information uniquely allocated to the recording apparatus, wherein the instructions, cause the computer to perform: reading media identification information for specifically identifying the recordable medium, and encrypted disk key information which is disk key information encrypted by master key information, from the recordable medium; transmitting the media identification information and the encrypted disk key information to the authentication server; receiving the encrypted content which is a content encrypted by title key information uniquely allocated to each content, and encrypted title key information which is the title key information encrypted by the disk key information, from the authentication server; receiving first certificate information for certifying that the authentication server permits recording of the content on the recordable medium, which is generated by using at least the media identification information, from the authentication server; generating second certificate information by using the first certificate information and the first secret information; and recording the encrypted content, the encrypted title key information, and the second certificate information on the recordable medium.

According to still another aspect of the present invention, a computer program product having a computer readable medium including programmed instructions, when executed by a computer provided in a reproducing apparatus that reproduces a content encrypted by title key information uniquely allocated to each content and recorded on a recordable medium, and includes a storage unit that stores master key information, wherein the instructions, cause the computer to perform: reading encrypted disk key information which is disk key information encrypted by the master key information, and encrypted title key information which is the title key information encrypted by the disk key information, from the recordable medium; obtaining the title key information by decrypting the encrypted disk key information by using the master key information and decrypting the encrypted title key information by using the decrypted disk key information; verifying whether recording of the encrypted content on the recordable medium is permitted by an authentication server, by using at least media identification information capable of specifically identifying the recordable medium, and second certificate information generated by a recording apparatus by using first certificate information, which is generated by using at least the media identification information, for certifying that the authentication server permits recording of the content on the recordable medium, and first secret information uniquely allocated to the recording apparatus, when the media identification information and the second certificate information are recorded on the recordable medium; reading the content from the recordable medium, when it is verified that recording of the content on the recordable medium is permitted by the authentication server; and decrypting the read content by using the obtained title key information to reproduce the content.

### BRIEF DESCRIPTION OF THE DRAWINGS

FIG. 1 is a diagram illustrating an example of a configuration of a recording and reproducing apparatus according to an embodiment of the present invention;

FIG. 2 is a diagram illustrating an outline of a process procedure for recording an encrypted content according to a conventional CSS;

FIG. 3 is a diagram illustrating an outline of a process procedure for recording an encrypted content by a CPRM technology;

FIG. 4 is a flowchart of a recording process procedure performed by a recording and reproducing apparatus according to the embodiment;

FIG. 5 is a flowchart of a reproduction process procedure of reproducing an encrypted content recorded on a recordable type DVD by the recording and reproducing apparatus; and

FIG. 6 is a flowchart of a reproduction process procedure performed by a recording and reproducing apparatus according to a modification.

### DETAILED DESCRIPTION OF THE INVENTION

Exemplary embodiments of a recording apparatus, a reproducing apparatus, a recording program, and a computer program product for recording and reproducing according to the present invention will be explained below in detail with reference to the accompanying drawings.

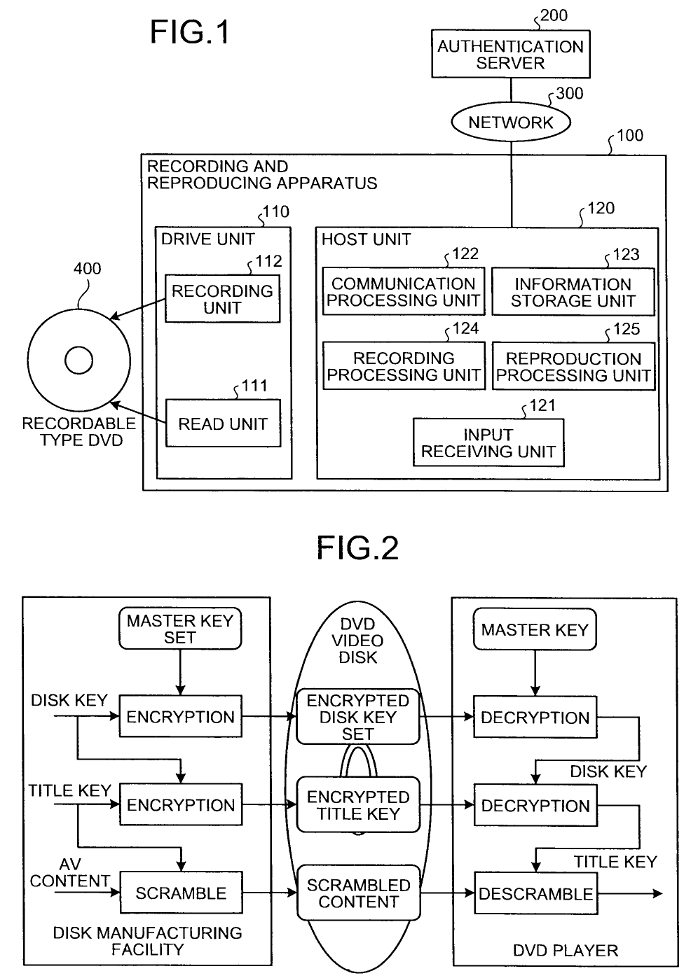

FIG. 1 depicts a configuration of a recording and reproducing apparatus 100 according to an embodiment of the present invention. The recording and reproducing apparatus 100 includes, for example, a DVD player that performs recording on the DVD and reproduction. The recording and reproducing apparatus 100 is connected to an authentication server 200 via a network 300 such as the Internet. The authentication server 200 is a server that permits recording of the content, and records the content encrypted by using a title key uniquely allocated to the content (encrypted content) and the master key.

The recording and reproducing apparatus 100 includes, as shown in FIG. 1, a drive unit 110 that records data on a data-writable recording type DVD 400 and reads data from the recordable type DVD (recordable-DVD) 400, and a host unit 120 that controls recording of the encrypted content on the recordable-DVD 400 and reproduction thereof. The drive unit 110 and the host unit 120 are connected via a general-purpose bus or a dedicated special bus.

The recording and reproducing apparatus 100 communicates with the authentication server 200 at the time of recording the encrypted content on the recordable-DVD 400, and obtains various types of first authentication information related to recording permission of the encrypted content together with the encrypted content, to record various types of second authentication information based on the various types of first authentication information, together with the encrypted content on the recordable-DVD. At the time of reproducing the encrypted content recorded on the recordable-DVD 400, the recording and reproducing apparatus 100 reads the various types of second authentication information recorded on the recordable-DVD to perform authentication related to the recording permission of the encrypted content, and according to the authentication result, decrypts the encrypted content to obtain and reproduce the content. The recording and reproducing apparatus 100 uses the CSS content protection system to perform recording of the encrypted content on the recordable-DVD 400 and reproduction thereof. Recordable type media have a data recording area (user data area) in which the user can freely write, and a management area (lead-in area) in which data is pre-written at the time of production, which cannot be rewritten by the user. In the management area (lead-in area), information is prerecorded at the time of production of the recordable-DVD 400, and the recording and reproducing apparatus 100 reads the information to control recording of data on the recordable-DVD 400 and reproduction thereof.

An encryption recording system for encrypting the content and recording the content on the recordable-DVD 400, and the information prerecorded in the management area (lead-in area) of the recordable-DVD 400 according to the present embodiment are explained below. First, an outline of a process procedure for recording the encrypted content according to the conventional CSS is explained with reference to FIG. 2. Because the CSS is a content protection system proposed for recording contents on the package media, various key data and the encrypted content is all recorded in a read-only format. Particularly, a set of encrypted disk keys (encrypted disk key set) in which a plurality of disk keys allocated to the package media is respectively encrypted is recorded in the management area (lead-in area) on the media. On the other hand, a master key for decrypting the encrypted disk key is confidentially held in the DVD player in advance at the time of production. The master key is not specific to each DVD player, but specific to each player manufacturer.

When the CSS is applied to the recordable-DVD, the encrypted disk key set is recorded on the recordable-DVD at the time of production. In a content recording apparatus, when the CSS encrypted content is recorded on the recordable-DVD, the encrypted disk key corresponding to the master key is selected from the encrypted disk key set, the master key is used to decrypt the encrypted disk key, the decrypted disk key is used to encrypt the title key and the content, and the encrypted title key and the content is recorded in the data recording area (user data area). When the encrypted content recorded on the recordable-DVD are reproduced, in the DVD player, the encrypted disk key is decrypted by using the master key held in the device itself, and the encrypted title key is decrypted by using the encrypted disk key, which is then used to decrypt the encrypted content to reproduce the content.

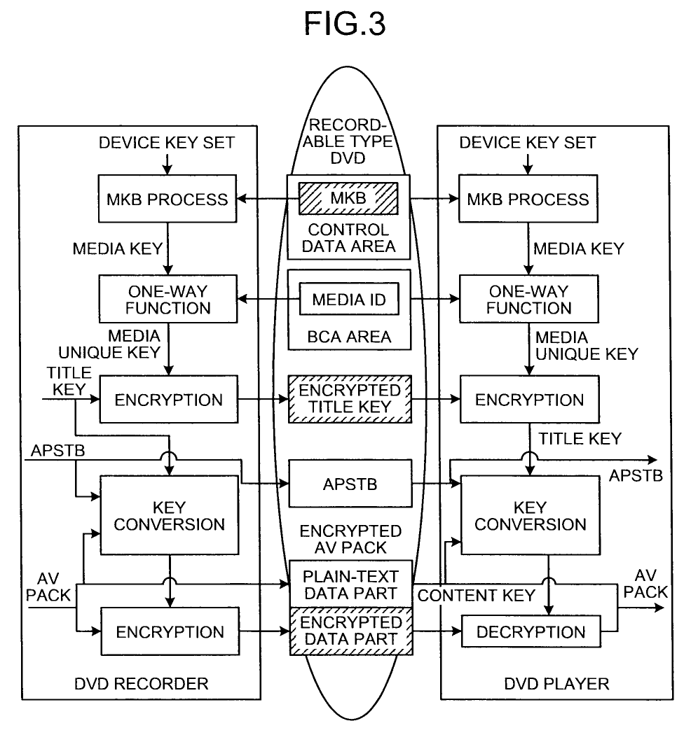

On the other hand, FIG. 3 depicts an outline of a process procedure for recording the encrypted content according to the content protection system by the CPRM. The CPRM is a content protection system proposed for recording contents on the recordable type media. In the CPRM, a new technique such as revocation technique of illegal equipment is adopted. To prevent bit-by-bit copy between the recordable type media, a media ID capable of specifically identifying the medium is written in the management area (lead-in area) of the recordable type medium at the time of production. The media ID is used at the time of reproducing the encrypted content written in the data recording area (user data area).

Based on such an encryption system, in the encryption recording system according to the present embodiment, illegal copying of the encrypted content recorded on the recordable-DVD 400 can be suppressed by using the media ID used in the CPRM as well as the CSS procedure. Therefore, at the time of production of the recordable-DVD 400, the media ID capable of specifically identifying the recordable-DVD 400 is prerecorded in the management area (lead-in area) in addition to the encrypted disk key set. The encrypted content recorded on the recordable-DVD 400 are all associated with the disk key and the media ID and protected.

Returning to FIG. 1, the detailed configuration of the recording and reproducing apparatus 100 for realizing the encryption recording system is explained. The host unit 120 mainly includes an input receiving unit 121, a communication processing unit 122, an information storage unit 123, a recording processing unit 124, and a reproduction processing unit 125. The drive unit 110 mainly includes a read unit 111 and a recording unit 112. The read unit 111 reads data recorded on the recordable-DVD 400 under control of the host unit 120. The recording unit 112 records data on the recordable-DVD 400 under control of the host unit 120.

The information storage unit 123 stores a public-key cryptography private key for storage device (first secret information) and a public key certificate for storage device (first public key information) in which a public key for the storage device is recorded, which are used at the time of recording the encrypted content on the recordable-DVD 400, and a master key (master key information) and a public key for management organization (management-organization public key information) used at the time of reproducing the encrypted content from the recordable-DVD 400.

The public-key cryptography private key for storage device is a key specific to the recording and reproducing apparatus 100. The public key certificate for storage device specifically corresponds to the public-key cryptography private key for storage device, to certify the validity thereof. The public key for storage device is used for authentication of digital signature in a media bind certificate with signature for storage device (second certificate information) described later. The master key is a private key specific to each manufacturer, and is used for decryption of the encrypted disk key corresponding to the master key, of the encrypted disk key set recorded on the recordable-DVD 400, and the disk key is used for decryption of the encrypted title key. The master key is also held in the authentication server 200 and other DVD players. The public key for management organization is issued from a management organization, which is a predetermined license organization, and is used for authentication of digital signature in the public key certificate for storage device and a content certificate with signature of management organization described later.

The input receiving unit 121 receives a request input from a user who requests recording or reproduction of the content. The recording processing unit 124 controls recording on the recordable-DVD 400 based on the encrypted content received from the authentication server 200 and various types of first authentication information, in response to a recording request input for requesting recording of the content.

Various types of first authentication information are the encrypted title key (encrypted title key information), the content certificate with signature of management organization (management organization certificate information), and the media bind certificate (first certificate information). The encrypted title key is obtained by encrypting the title key for decrypting the encrypted content with the disk key encrypted by the master key. The content certificate with signature of management organization is information specifically associated with the encrypted content, to which digital signature is added in advance by the management organization, and includes information capable of detecting falsification, for example, a hash value of the encrypted content and the digital signature. The media bind certificate is a digital signature specifically corresponding to the media ID, the encrypted content, and the authentication server 200, details of which will be described later.

Specifically, the recording processing unit 124 transmits a transmission request for requesting transmission of the content, including the encrypted disk key set and the media ID stored on the recordable-DVD 400, to the authentication server 200 via the communication processing unit 122. Upon reception of the encrypted content and the various types of first authentication information, transmitted from the authentication server 200 in response to the transmission request, via the communication processing unit 122, the recording processing unit 124 records the encrypted content on the recordable-DVD 400, and also records the encrypted title key and the content certificate with signature of management organization, among the various types of first authentication information received from the authentication server 200, on the recordable-DVD 400. Moreover, the recording processing unit 124 uses the public-key cryptography private key for storage device stored in the information storage unit 123 to generate a digital signature for the media bind certificate received from the authentication server 200. This is referred to as a media bind certificate with signature for storage device (second certificate information). The recording processing unit 124 records the generated media bind certificate with signature for storage device and the public key certificate for storage device stored in the information storage unit 123 on the recordable-DVD 400. As a result, the encrypted title key, the content certificate with signature of management organization, the media bind certificate with signature for storage device, and the public key certificate for storage device are stored on the recordable-DVD 400 as second authentication information together with the encrypted content.

The reproduction processing unit 125 controls reproduction of the encrypted content by using various pieces of information stored on the recordable-DVD 400, in response to a request input from the user who requests reproduction of the content. Specifically, the reproduction processing unit 125 uses the master key stored in the information storage unit 123 to decrypt the encrypted disk key recorded on the recordable-DVD 400, to thereby obtain the disk key, and uses the obtained disk key to decrypt the encrypted title key to thereby obtain the title key. The reproduction processing unit 125 performs authentication of the digital signature in the content certificate with signature of management organization recorded on the recordable-DVD 400, and continues or aborts the processing according to the authentication result. When the processing is continued, the reproduction processing unit 125 compares a hash value of the encrypted content with the hash value of the encrypted content included in the content certificate with signature of management organization, to continue or abort the processing according to the comparison result. When the processing is continued, the reproduction processing unit 125 performs authentication of the digital signature in the public key certificate for storage device, to continue or abort the processing according to the authentication result. When the processing is continued, the reproduction processing unit 125 performs authentication of the digital signature in the media bind certificate with signature for storage device, to continue or abort the processing according to the authentication result. When the processing is continued, the reproduction processing unit 125 uses the decrypted title key to decrypt the encrypted content, to thereby obtain the content, and reproduces the content.

The communication processing unit 122 performs physical layer processing for communicating with the authentication server 200, data link layer processing, network layer processing, and transport layer processing.

The authentication server 200 according to the present embodiment is explained next. The authentication server 200 stores the content certificate with signature of management organization and a public-key cryptography private key for server uniquely allocated to the authentication server 200 in addition to the encrypted content, the title key, and the master key. Upon reception of the transmission request for requesting transmission of the content to be recorded, which includes the encrypted disk key set and the media ID, from the recording and reproducing apparatus 100, the authentication server 200 decrypts the encrypted disk key corresponding to the master key stored in the device itself, of the encrypted disk key set, by using the master key, to obtain the disk key. The authentication server 200 then encrypts the title key corresponding to the content to be recorded by using the disk key, to thereby generate the encrypted title key. The authentication server 200 then generates the media bind certificate by using the hash value of the title key, the public-key cryptography private key for server stored in the device itself, and the media ID received from the recording and reproducing apparatus 100. The authentication server 200 then transmits the generated encrypted title key and the media bind certificate, the encrypted content prestored in the device itself, and the content certificate with signature of management organization to the recording and reproducing apparatus 100.

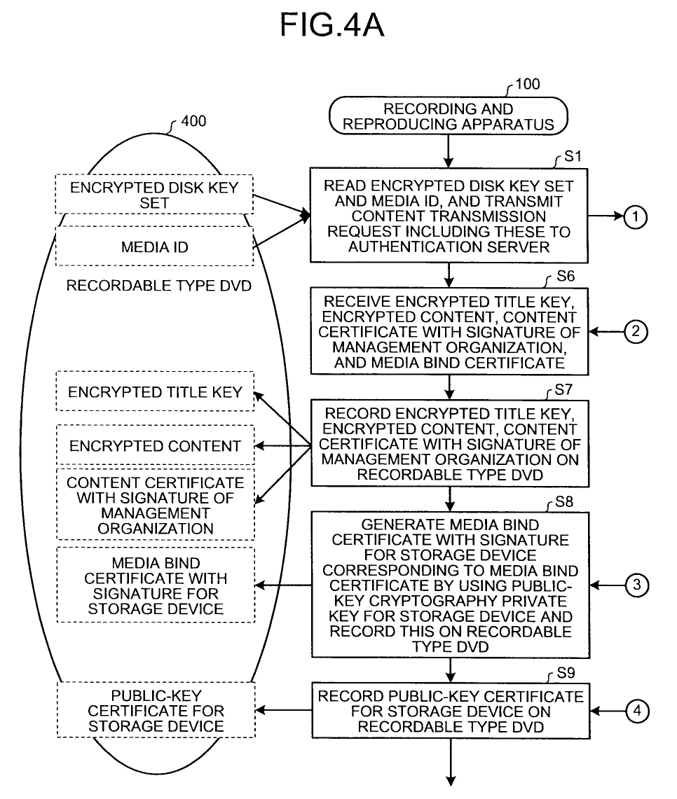

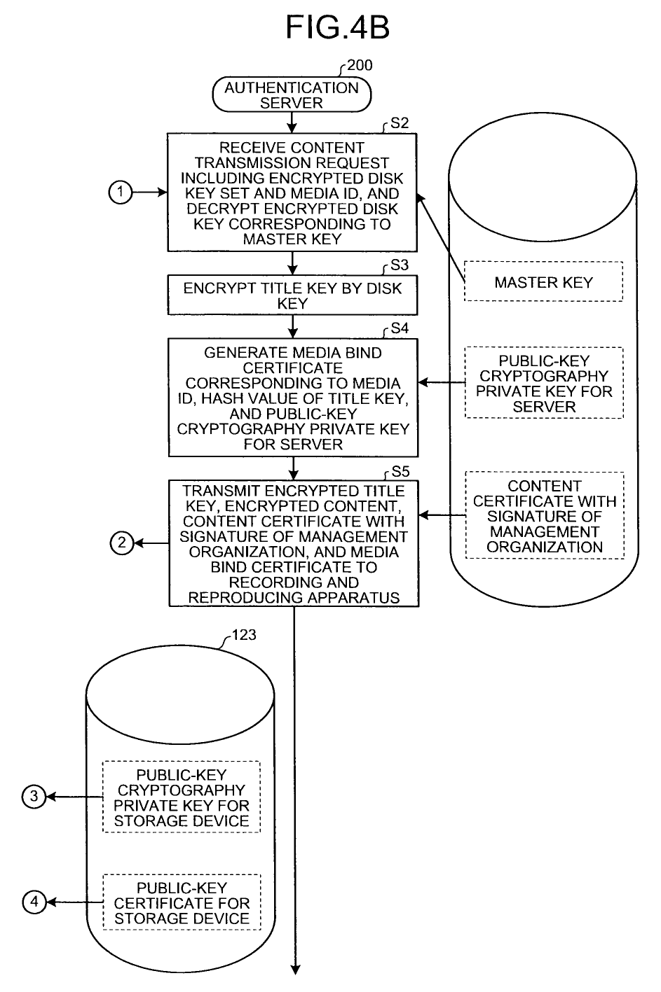

A recording process procedure performed by the recording and reproducing apparatus 100 is explained with reference to FIG. 4. Upon reception of a recording request input for requesting the content to be recorded, the recording and reproducing apparatus 100 reads the encrypted disk key set and the media ID prerecorded on the recordable-DVD 400 as a recording target, and transmits a transmission request for requesting transmission of the content to be recorded, including the encrypted disk key set and the media ID, to the authentication server 200 (Step S1).

Upon reception of the transmission request, the authentication server 200 selects the encrypted disk key corresponding to the master key stored in the device itself from the encrypted disk key set included in the transmission request, and decrypts the encrypted disk key by using the master key, to thereby obtain the disk key (Step S2). The authentication server 200 encrypts the title key used for encryption of the encrypted content in which the content to be transmitted are encrypted with the disk key decrypted at Step S2, to generate the encrypted title key (Step S3). The authentication server 200 reads the content certificate with signature of management organization and calculates the hash value of the title key. The authentication server 200 then generates a digital signature (media bind certificate) corresponding to the calculated hash value of the title key and the media ID received at Step S2 by using the public-key cryptography private key for server stored in the device itself (Step S4). The authentication server 200 then transmits the encrypted title key generated at Step S3, the encrypted content prestored in the device itself, the content certificate with signature of management organization, and the media bind certificate generated at Step S4 to the recording and reproducing apparatus 100 (Step S5).

Upon reception of the encrypted title key, the encrypted content, the content certificate with signature of management organization, and the media bind certificate transmitted at Step S5 (Step S6), the recording and reproducing apparatus 100 records these except of the media bind certificate on the recordable-DVD 400, from which the media ID has been read at Step S1 (Step S7). The recording and reproducing apparatus 100 then generates a digital signature corresponding to the media bind certificate (media bind certificate with signature for storage device) by using the public-key cryptography private key for storage device prestored in the device itself (Step S8). The recording and reproducing apparatus 100 records the media bind certificate with signature for storage device generated at Step S8 on the recordable-DVD 400, from which the media ID has been read at Step S1, and also records the public key certificate for storage device prestored in the device itself on the recordable-DVD 400 (Step S9).

When the encrypted content is downloaded and recorded on the recordable-DVD by using the CSS, the media ID is recorded on the recordable-DVD as in the case of recording the encrypted content by using the CPRM. The media ID and the encrypted content encrypted by the CSS are connected in one-to-one association, and the digital signature generated by using the public-key cryptography private key for server uniquely allocated to the authentication server 200 for specifying the authentication server 200 is issued as the media bind certificate. Moreover, the recording and reproducing apparatus 100 issues the media bind certificate with signature for storage device by using the public-key cryptography private key for storage device uniquely allocated to the recording and reproducing apparatus 100. As a result, the encrypted content, the recordable-DVD 400 on which the encrypted content is recorded, and the authentication server 200 that authenticates recording of the encrypted content on the recordable-DVD can be specifically associated with each other, and discrimination of illegally copied encrypted content becomes possible.

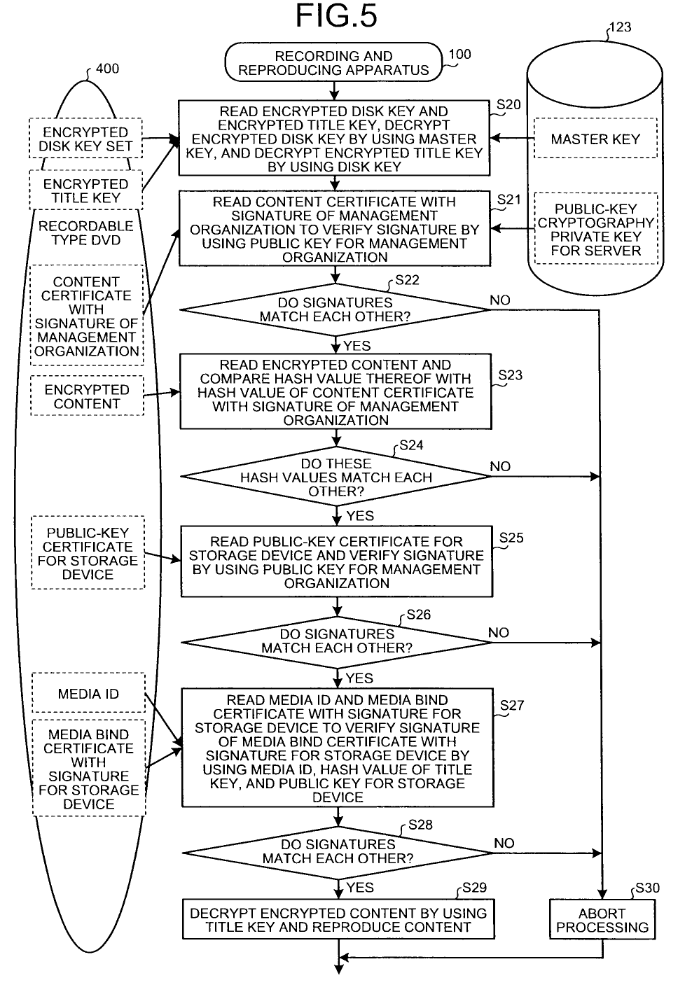

A reproduction process procedure of the encrypted content recorded on the recordable-DVD 400 according to the above procedure performed by the recording and reproducing apparatus 100 is explained with reference to FIG. 5. Upon reception of a reproduction request input for reproducing the encrypted content recorded on the recordable-DVD 400, the recording and reproducing apparatus 100 reads the encrypted disk key set and the encrypted title key recorded on the recordable-DVD 400, and decrypts at least one encrypted disk key among the encrypted disk key set by using the master key, to obtain the disk key, and decrypts the encrypted title key by using the disk key to obtain the title key (Step S20). The recording and reproducing apparatus 100 then reads the content certificate with signature of management organization recorded on the recordable-DVD 400, to verify the digital signature on the content certificate with signature of management organization by using the public key for management organization prestored in the device itself (Step S21). As a result of authentication, if the digital signatures do not match each other (NO at Step S22), the recording and reproducing apparatus 100 regards the encrypted content to be reproduced is an illegal content, and aborts the process (Step S30).

As a result of authentication, if the digital signatures match each other (YES at Step S22), the recording and reproducing apparatus 100 reads the encrypted content to be reproduced recorded on the recordable-DVD 400, calculates a hash value by performing predetermined processing, and compares the calculated hash value with the hash value included in the content certificate with signature of management organization read at Step S21, to perform authentication (Step S23). As a result of authentication, if the hash values do not match each other (NO at Step S24), control proceeds to Step S30. As a result of authentication, if the hash values match each other (YES at Step S24), the recording and reproducing apparatus 100 reads the public key certificate for storage device stored on the recordable-DVD 400, and verifies the digital signature on the public key certificate for storage device by using the public key for management organization prestored in the device itself (Step S25). As a result of authentication, if the digital signatures do not match each other (NO at Step S26), control proceeds to Step S30.

As a result of authentication, if the digital signatures match each other (YES at Step S26), the recording and reproducing apparatus 100 calculates a hash value from the title key decrypted at Step S20, reads the media ID and the media bind certificate with signature for storage device stored on the recordable-DVD 400, and verifies the digital signature on the media bind certificate with signature for storage device by using the public key for storage device recorded in the public key certificate for storage device read at Step S25 (Step S27). As a result of authentication, if the digital signatures do not match each other (NO at Step S28), control proceeds to Step S30. As a result of authentication, if the digital signatures match each other (YES at Step S28), the recording and reproducing apparatus 100 decrypts the encrypted content read at Step S23 by using the title key decrypted at Step S20, to obtain the content, and reproduces the content (Step S29).

Thus, the reproduction process is performed by using the media ID, the public-key certificate for storage device, the content certificate with signature of storage device, and the public key for management organization prestored in the recording and reproducing apparatus 100 at the time of production. Therefore, when the authentication result of the content certificate with signature of management organization is negative, it means that the content certificate with signature of management organization does not correspond to the encrypted content. Accordingly, the recording and reproducing apparatus 100 determines that the encrypted content is a content illegally encrypted and recorded, to thereby inhibit reproduction of the content. Further, when the authentication result of the media bind certificate with signature for storage device is negative, it means that the media bind certificate with signature for storage device does not correspond to the media ID. Accordingly, recording and reproducing apparatus 100 determines that the content is illegally copied on another recordable-DVD having a different media ID, to thereby inhibit reproduction of the content. As a result, illegal copying of the encrypted content can be suppressed.

That is, according to the present embodiment, when the encrypted content is downloaded and recorded on the recordable-DVD by using the CSS, the encrypted content obtained by illegal bit-by-bit copy or copied by illegally using the public-key certificate for storage device and the public key for management organization confidentially held by the recording and reproducing apparatus 100 can be discriminated. Therefore, a content provider can provide a download service without anxiety.

When the encrypted contents recorded by the recording and reproducing apparatus 100 are reproduced by a conventional DVD player, reproduction can be performed by the same processing as that of the DVD player shown in FIG. 2. That is, in the conventional DVD player, because the presence of the media ID, the public-key certificate for storage device, the content certificate with signature of management organization, and the media bind certificate with signature for storage device is not taken into consideration, encrypted content can be reproduced without using these. Therefore, such a problem can be avoided that the encrypted content recorded by the recording and reproducing apparatus 100 cannot be reproduced by the conventional DVD player, although it is not copied illegally.

Discrimination information for discriminating the recordable-DVD 400, on which the encrypted content is recorded by the recording method according to the present embodiment from a recordable-DVD, on which the encrypted content is encrypted by the CSS and recorded in the conventional manner can be separately provided. That is, information for discriminating the recordable-DVD that records at least the media bind certificate with signature for storage device at the time of recording the encrypted content permitted by the authentication server 200 from a conventional recordable-DVD that does not record at least the media bind certificate with signature for storage device at the time of recording the encrypted content permitted by any authentication server can be separately provided. For example, a digital watermark can be used as the information for discriminating the encrypted content from the conventional encrypted content. Specifically, a digital watermark indicating that the authentication server, which permits recording of contents, permits recording of the content on a target recordable-DVD is embedded in the content, and the content encrypted by the title key are recorded on the recordable-DVD 400. At the time of reproducing the content obtained by decrypting the encrypted content, the recording and reproducing apparatus 100 detects the digital watermark embedded in the content. As in the present embodiment, authentication is then performed by using the media ID, the public-key certificate for storage device, the media bind certificate with signature for storage device, and the content certificate with signature of management organization, and reproduction of the content is aborted or continued according to the authentication result. When the recording and reproducing apparatus 100 does not detect the corresponding digital watermark at the time of reproducing the content, reproduction of the content is continued.

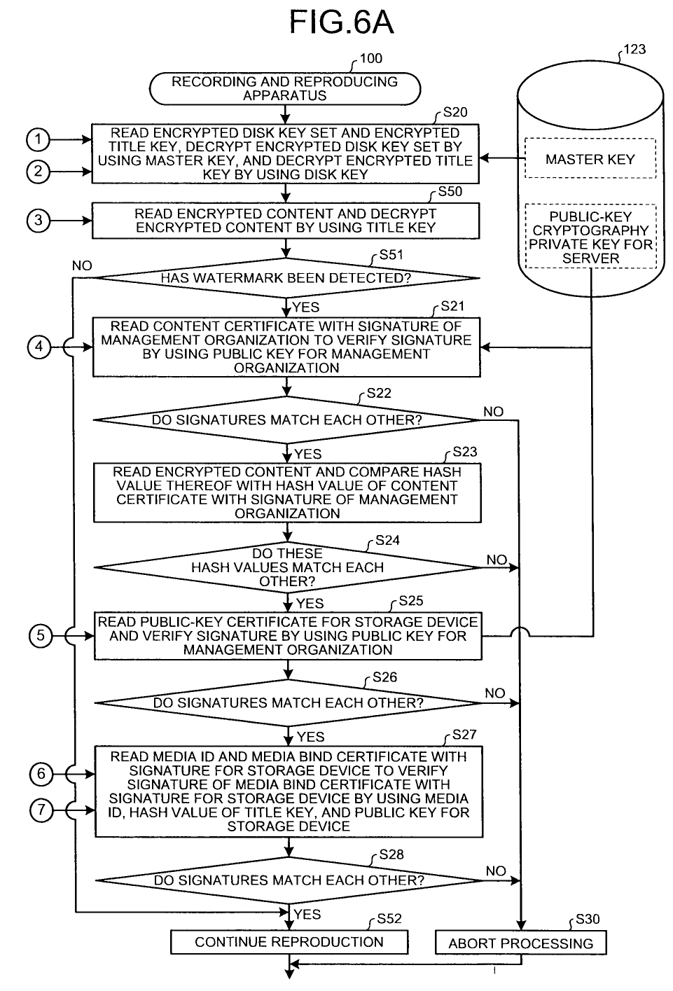

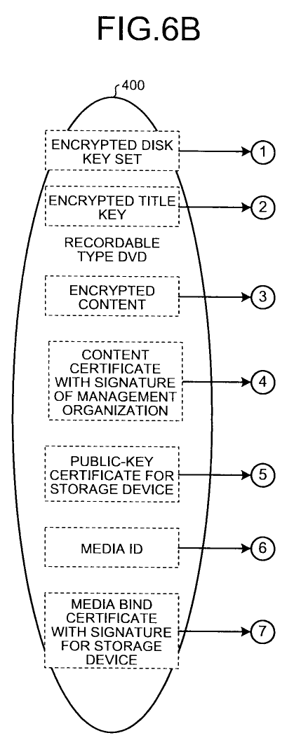

FIG. 6 is a flowchart of a reproduction process procedure performed by the recording and reproducing apparatus 100 according to a modification. Step S20 is the same as in the present embodiment. After Step S20, at Step S50, the recording and reproducing apparatus 100 reads the encrypted content recorded on the recordable-DVD 400 and decrypts the encrypted content by using the title key obtained at Step S20, to thereby start reproduction. At this time, when having detected the corresponding digital watermark (YES at Step S51), the recording and reproducing apparatus 100 performs the process at Step S21 in the same manner as in the present embodiment. At Step S21, if the content certificate with signature of management organization is not recorded on the recordable-DVD 400, the determination result at Step S22 is negative, to thereby proceed to Step S29. At Step S25, if the public-key certificate for storage device is not recorded on the recordable-DVD 400, the determination result at Step S26 is negative, to thereby proceed to Step S29. Further, at Step S27, if the media bind certificate with signature for storage device is not recorded on the recordable-DVD 400, the determination result at Step S28 is negative, to thereby proceed to Step S29. When the content certificate with signature of management organization, the public-key certificate for storage device, and the media bind certificate with signature for storage device are recorded on the recordable-DVD 400, and as a result of authentication at Step S28, when the digital signatures match each other, the recording and reproducing apparatus 100 continues reproduction of the content (Step S52). When the corresponding digital watermark is not detected (NO at Step S51), the recording and reproducing apparatus 100 continues reproduction of the content at Step S52.

According to such a configuration, discrimination between a recordable-DVD on which a content is encrypted and recorded by the CSS in the conventional manner and the content certificate with signature of management organization, the media bind certificate with signature for storage device, and the public-key certificate for storage device are not recorded, and a recordable-DVD on which a content is encrypted and recorded by the encryption recording system in the present embodiment and the content certificate with signature of management organization, the media bind certificate with signature for storage device, and the public-key certificate for storage device are recorded becomes easy. That is, if a digital watermark is not embedded in the content obtained by decrypting the encrypted content read from the recordable-DVD, it can be determined that the encrypted content is recorded in the conventional manner. On the other hand, when the content certificate with signature of management organization, the media bind certificate with signature for storage device, and the public-key certificate for storage device are not recorded on the recordable-DVD, although the digital watermark is embedded therein, or the result of authentication using these is negative, it can be determined that the content is illegally recorded. By aborting reproduction of the illegally recorded encrypted content, illegal copying of the encrypted content can be suppressed as a result.

Further, the discrimination information is not limited to a digital watermark. For example, discrimination information indicating a predetermined value can be prerecorded in the management area (lead-in area) of the recordable-DVD 400 at the time of production. In this case, at the time of reproduction of the encrypted content recorded on the recordable-DVD 400, when having detected the discrimination information by referring to the management area (lead-in area) of the recordable-DVD, the recording and reproducing apparatus 100 performs processing at and after Step S52. When the discrimination information is not detected, the recording and reproducing apparatus 100 decrypts the encrypted content at Step S52 to reproduce the content, without performing the processing at and after Step S21.

In the present embodiment, various programs executed by the recording and reproducing apparatus 100 can be stored on a computer connected to a network such as the Internet and provided by downloading the programs. Further, the various programs can be recorded on a computer readable recordable medium such as a compact disc ROM (CD-ROM), a flexible disc (FD), a CD recordable (CD-R), or a DVD, and provided in an installable format or an executable format.

In the present embodiment, the recording and reproducing apparatus 100 includes both the functions of recording the encrypted content on the recordable-DVD and reproducing the encrypted content recorded on the recordable-DVD by decrypting the encrypted content. However, the recording and reproducing apparatus 100 can be an apparatus including either one function. In this case, the apparatus having the recording function needs only to store at least the public-key certificate for storage device in which the public-key cryptography private key for storage device and the public key for storage device are recorded. The apparatus having the reproduction function needs only to store at least the master key and the public key for management organization.

In the present embodiment, at the time of recording the encrypted content on the recordable-DVD 400, the recording and reproducing apparatus 100 transmits a transmission request for requesting transmission of the content to be recorded, which includes the encrypted disk key set and the media ID, to the authentication server 200. However, the recording and reproducing apparatus 100 can transmit the encrypted disk key set and the media ID, and the transmission request for requesting transmission of the content to be recorded at different timing. Further, the recording and reproducing apparatus 100 can transmit information specifying the content to be recorded as a transmission request.

Further, the recording and reproducing apparatus 100 can be connected to an information processor, to thereby control recording and reproduction of the encrypted content with respect to the recordable-DVD 400, in response to a transmission request and a reproduction request from the information processor.

In the present embodiment, the media bind certificate is generated by using a hash value of the title key as content identification information capable of specifically identifying the content. However, the content identification information is not limited thereto, and for example, a hash value of the encrypted content can be used.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A recording apparatus connected to an authentication server that permits recording of a content via a network, to record an encrypted content on a recordable medium, comprising:
a storage unit that stores first secret information uniquely allocated to the recording apparatus;
a reading unit that reads media identification information for specifically identifying the recordable medium, and encrypted disk key information which is disk key information encrypted by master key information, from the recordable medium;
a transmitting unit that transmits the media identification information and the encrypted disk key information to the authentication server;
a first receiving unit that receives the encrypted content which is a content encrypted by title key information uniquely allocated to each content, and encrypted title key information which is the title key information encrypted by the disk key information, from the authentication server;
a second receiving unit that receives first certificate information for certifying that the authentication server permits recording of the content on the recordable medium, which is generated by using at least the media identification information, from the authentication server;
a generating unit that generates second certificate information by using the first certificate information and the first secret information; and
a recording unit that records the encrypted content, the encrypted title key information, and the second certificate information on the recordable medium.

2. The apparatus according to claim 1, wherein the second receiving unit receives the first certificate information generated by using the media identification information, a second secret information uniquely allocated to the authentication server, and a content identification information from the authentication server.

3. The apparatus according to claim 2, wherein the second receiving unit receives a hash value calculated from the title key information used for encrypting the content, as the content identification information.

4. The apparatus according to claim 1, wherein the storage unit further stores first public key certificate information specifically corresponding to the first secret information, and
the recording unit further records the first public key certificate information on the recordable medium.

5. The apparatus according to claim 1, wherein the second receiving unit further receives management-organization certificate information, which is capable of specifically identifying the content and has a digital signature issued in advance by a management-organization added thereto, and
the recording unit further records the management-organization certificate information on the recordable medium.

6. The apparatus according to claim 5, wherein the second receiving unit receives the management-organization certificate information added with the digital signature issued in advance by the management-organization and including a hash value of the encrypted content.

7. The apparatus according to claim 1, wherein the first receiving unit receives the encrypted content in which the content having a digital watermark embedded therein is encrypted by the title key information, and the encrypted title key information from the authentication server.

8. The apparatus according to claim 1, wherein the recording unit records the encrypted content, the encrypted title key information, and the second certificate information on the recordable medium, on which discrimination information for discriminating a recordable medium having at least the media identification information and the second certificate information recorded thereon at the time of recording the encrypted content permitted by the authentication server, from a recordable medium on which the media identification information and the second certificate information are not recorded at the time of recording the encrypted content permitted by the authentication server is prerecorded unrewritably.

9. A reproducing apparatus that reproduces a content encrypted and recorded on a recordable medium, comprising:
a storage unit that stores master key information;
a read unit that reads encrypted disk key information which is disk key information encrypted by the master key information, an encrypted content which is a content encrypted by title key information uniquely allocated to each content, and encrypted title key information which is the title key information encrypted by the disk key information, from the recordable medium;
a decrypting unit that decrypts the encrypted disk key information by using the master key information, and decrypts the encrypted title key information by using the decrypted disk key information, thereby obtaining the title key information;
a verifying unit that verifies whether recording of the encrypted content on the recordable medium is permitted by an authentication server, by using at least media identification information capable of specifically identifying the recordable medium, and second certificate information generated by a recording apparatus by using first certificate information, which is generated by using at least the media identification information, for certifying that the authentication server permits recording of the content on the recordable medium, and first secret information uniquely allocated to the recording apparatus, when the media identification information and the second certificate information are recorded on the recordable medium; and
a reproducing unit that decrypts the encrypted content by using the title key information to reproduce the content, when it is verified that recording of the encrypted content on the recordable medium is permitted by the authentication server.

10. The apparatus according to claim 9, wherein the verifying unit verifies whether recording of the encrypted content on the recordable medium is permitted by the authentication server by using the media identification information, the second certificate information, and the first public key certificate information specifically corresponding to the first secret information, when the media identification information, the second certificate information, and the first public key certificate information are further recorded on the recordable medium.

11. The apparatus according to claim 10, wherein
the storage unit stores management-organization public key information specifically corresponding to management-organization certificate information added with a digital signature issued in advance by a management-organization and capable of specifically identifying the content, and
when the media identification information, the second certificate information, the first public key certificate information, and the management-organization certificate information are further recorded on the recordable medium, the verifying unit verifies the management-organization certificate information by using the management-organization public key information, and according to a verification result thereof, verifies the first public key certificate information by using the management-organization public key information, and according to a verification result thereof, verifies whether recording of the encrypted content on the recordable medium is permitted by the authentication server, by using the media identification information, the second certificate information, and the first public key certificate information.

12. The apparatus according to claim 10, wherein the management-organization certificate information includes a hash value calculated from the encrypted content,
the apparatus further comprises a first calculating unit that calculates a hash value of the encrypted content recorded on the recordable medium is further included, and
the verifying unit compares the calculated hash value of the encrypted content with the hash value included in the management-organization certificate information recorded on the recordable medium, and when these hash values match each other, verifies the management-organization certificate information by using the management-organization public key information.

13. The apparatus according to claim 10, wherein the second certificate information is generated by using the first certificate information generated by using the media identification information, the second secret information uniquely allocated to the authentication server, and the hash value calculated from the title key information used for encryption of the content, and the first secret information,
the apparatus further comprises a second calculating unit that calculates a hash value of the obtained disk key information is further included, and
the verifying unit verifies whether recording of the encrypted content on the recordable medium is permitted by the authentication server, by using the media identification information, the second certificate information, the first public key certificate information, and the hash value of the disk key information.

14. The apparatus according to claim 9, wherein when it is verified that recording of the encrypted content on the recordable medium is not permitted by the authentication server, the reproducing unit does not reproduce the content.

15. The apparatus according to claim 9, wherein when at least the media identification information and the second certificate information are not recorded on the recordable medium, the reproducing unit decrypts the encrypted content by using the obtained title key information, to obtain and reproduce the content.

16. The apparatus according to claim 9, wherein the recordable medium further records discrimination information for discriminating a recordable medium having at least the media identification information and the second certificate information recorded thereon at the time of recording the encrypted content permitted by the authentication server, from a recordable medium on which the media identification information and the second certificate information are not recorded at the time of recording the encrypted content permitted by the authentication server,
the apparatus further comprises a detecting unit that detects the discrimination information recorded on the recordable medium is further included, and
when the discrimination information is detected, and when the media identification information and the second certificate information are not recorded on the recordable medium, the reproducing unit does not reproduce the content.

17. The apparatus according to claim 16, wherein when the discrimination information is not detected, the reproducing unit decrypts the encrypted content by using the obtained title key information, to obtain and reproduce the content.

18. A reproducing apparatus that reproduces a content encrypted and recorded on a recordable medium, comprising:
a storage unit that stores master key information;
a read unit that reads encrypted disk key information, which is disk key information encrypted by the master key information, an encrypted content, which is a content having a digital watermark embedded therein for indicating that an authentication server that permits recording of contents permits recording of the content on the recordable medium and encrypted by title key information uniquely allocated to each content, and encrypted title key information, which is the title key information encrypted by the disk key information, from the recordable medium;
a decrypting unit that decrypts the encrypted disk key information by using the master key information, and decrypts the encrypted title key information by using the decrypted disk key information, to thereby obtain the title key information;
a reproducing unit that decrypts the encrypted content by using the title key information, to reproduce the content;
a detecting unit that detects the appropriate digital watermark from the content to be reproduced; and
a verifying unit that verifies whether recording of the encrypted content on the recordable medium is permitted by the authentication server, by using at least media identification information capable of specifically identifying the recordable medium, and second certificate information generated by a recording apparatus by using first certificate information, which is generated by using at least the media identification information, for certifying that the authentication server permits recording of the content on the recordable medium, and first secret information uniquely allocated to the recording apparatus, when the appropriate digital watermark is detected and the media identification information and the second certificate information are recorded on the recordable medium, wherein
when the appropriate digital watermark is detected and the media identification information and the second certificate information are not recorded on the recordable medium, or when it is verified that recording of the encrypted content is not permitted by the authentication server, the reproducing unit aborts reproduction of the content.

19. The apparatus according to claim 18, wherein when the appropriate digital watermark is not detected or when it is verified that recording of the encrypted content is permitted by the authentication server, the reproducing unit continues reproduction of the content.

20. A computer program product having a computer readable medium including programmed instructions, when executed by a computer provided in a recording apparatus connected to an authentication server that permits recording of a content via a network, to record an encrypted content on a recordable medium, and includes a storage unit that stores first secret information uniquely allocated to the recording apparatus, wherein the instructions, cause the computer to perform:
reading media identification information for specifically identifying the recordable medium, and encrypted disk key information which is disk key information encrypted by master key information, from the recordable medium;
transmitting the media identification information and the encrypted disk key information to the authentication server;
receiving the encrypted content which is a content encrypted by title key information uniquely allocated to each content, and encrypted title key information which is the title key information encrypted by the disk key information, from the authentication server;
receiving first certificate information for certifying that the authentication server permits recording of the content on the recordable medium, which is generated by using at least the media identification information, from the authentication server;
generating second certificate information by using the first certificate information and the first secret information; and
recording the encrypted content, the encrypted title key information, and the second certificate information on the recordable medium.

21. A computer program product having a computer readable medium including programmed instructions, when executed by a computer provided in a reproducing apparatus that reproduces a content encrypted by title key information uniquely allocated to each content and recorded on a recordable medium, and includes a storage unit that stores master key information, wherein the instructions, cause the computer to perform:
reading encrypted disk key information which is disk key information encrypted by the master key information, and encrypted title key information which is the title key information encrypted by the disk key information, from the recordable medium;
obtaining the title key information by decrypting the encrypted disk key information by using the master key information and decrypting the encrypted title key information by using the decrypted disk key information;
verifying whether recording of the encrypted content on the recordable medium is permitted by an authentication server, by using at least media identification information capable of specifically identifying the recordable medium, and second certificate information generated by a recording apparatus by using first certificate information, which is generated by using at least the media identification information, for certifying that the authentication server permits recording of the content on the recordable medium, and first secret information uniquely allocated to the recording apparatus, when the media identification information and the second certificate information are recorded on the recordable medium;
reading the content from the recordable medium, when it is verified that recording of the content on the recordable medium is permitted by the authentication server; and
decrypting the read content by using the obtained title key information to reproduce the content.
